(19) United States
(12) Patent Application Publication
(10) Pub. No.: US 2025/0337076 A1
(43) Pub. Date: Oct. 30, 2025

(54) BATTERY CASE

(71) Applicant: MURATA MANUFACTURING CO., LTD., Kyoto (JP)

(72) Inventor: Takumi OSHIDA, Kyoto (JP)

(21) Appl. No.: 19/262,404

(22) Filed: Jul. 8, 2025

Related U.S. Application Data
(63) Continuation of application No. PCT/JP2023/043667, filed on Dec. 6, 2023.

(30) Foreign Application Priority Data
Mar. 7, 2023 (JP) 2023-034813

(51) Int. Cl. H01M 50/242; H01M 50/213; H01M 50/244

(52) U.S. Cl. CPC H01M 50/242; H01M 50/213; H01M 50/244

(57) ABSTRACT

A battery case is provided and including a plurality of accommodating portions each accommodating one cylindrical battery cell, the accommodating portions 11 being arranged side by side in one direction, in which each of the accommodating portions has a wall portion defining a space for accommodating the cylindrical battery cell, the wall portion in a state before accommodating the cylindrical battery cell defines an elliptical cylindrical space, a direction in which the accommodating portions are arranged in one direction is defined as a long axis direction of the elliptical cylindrical space, a direction perpendicular to the long axis direction is defined as a short axis direction, and a direction perpendicular to the long axis direction and the short axis direction and parallel to a central axis of the elliptical cylindrical space is defined as a depth direction, and a longest long axis diameter in the long axis direction of the elliptical cylindrical space in each of the accommodating portions 11 is equal to or larger than a diameter of the cylindrical battery cell.

### CROSS REFERENCE TO RELATED APPLICATIONS

The present application is a continuation of International Application No. PCT/JP2023/043667, filed on Dec. 6, 2023, which claims priority to Japanese Patent Application No. 2023-034813, filed on Mar. 7, 2023, the entire contents of which are incorporated herein by reference.

### BACKGROUND

The present disclosure relates to a battery case.

A battery holder is described that holds a plurality of cylindrical batteries in an aligned state, the battery holder including a plurality of cylindrical battery storage portions that respectively store the batteries, in which each battery storage portion is formed by a substantially cylindrical wall portion having a spring property capable of deforming to expand a diameter of the battery storage portion at the time of inserting a battery.

### SUMMARY

The present disclosure relates to a battery case.

It is technically known that a cylindrical battery has dimensional tolerance in its size. Therefore, when a cylindrical battery having a large size within a range of the dimensional tolerance is stored in the battery storage portion capable of deforming to expand the diameter, the battery storage portion deforms to expand the diameter in accordance with the size of the cylindrical battery. Diameter expansion deformation of the battery storage portion affects other adjacent battery storage portions. For example, when one battery storage portion deforms to expand the diameter due to storage of the battery, the other battery storage portion adjacent to the one battery storage portion is deformed in shape due to the diameter expansion deformation of the one battery storage portion. The other battery storage portion may not be able to appropriately store the cylindrical battery depending on the degree of deformation.

In an embodiment, the present disclosure relates to providing a battery case capable of appropriately accommodating cylindrical battery cells.

### SUMMARY

A battery case according to the present disclosure, in an embodiment, is a battery case including a plurality of accommodating portions each accommodating one cylindrical battery cell, the accommodating portions being arranged side by side in one direction, in which
each of the accommodating portions has a wall portion defining a space for accommodating the cylindrical battery cell,
the wall portion in a state before accommodating the cylindrical battery cell defines an elliptical cylindrical space,
a direction in which the accommodating portions are arranged in one direction is defined as a long axis direction of the elliptical cylindrical space, a direction perpendicular to the long axis direction is defined as a short axis direction, and a direction perpendicular to the long axis direction and the short axis direction and parallel to the central axis of the elliptical cylindrical space is defined as a depth direction, and
a longest long axis diameter in the long axis direction of the elliptical cylindrical space in each of the accommodating portions is equal to or larger than a diameter of the cylindrical battery cell.

According to the battery case of the present disclosure, in an embodiment, it is possible to provide a battery case capable of appropriately accommodating the cylindrical battery cells. Specifically, in the accommodating portion having the elliptical cylindrical space, the longest long axis diameter in the long axis direction of the elliptical cylindrical space is equal to or larger than the diameter of the cylindrical battery cell, so that the cylindrical battery cell can be appropriately accommodated in the accommodating portion also when the diameter expansion deformation occurs in the accommodating portions adjacent to each other.

### BRIEF DESCRIPTION OF THE FIGURES

FIG. 1 is a perspective view schematically illustrating an embodiment of a battery case of the present disclosure.

FIG. 2 is a front view of an embodiment of the battery case of the present disclosure as viewed from an axial direction of the battery case.

FIG. 3 is a front view of the battery case according to a modification of an embodiment as viewed from the axial direction.

FIG. 4 is a perspective view schematically illustrating an embodiment of the battery case of the present disclosure.

FIG. 5 is a front view of an embodiment of the battery case of the present disclosure as viewed from the axial direction.

FIG. 6 is a perspective view schematically illustrating an embodiment of the battery case of the present disclosure.

FIG. 7 is a front view of an embodiment of the battery case of the present disclosure as viewed from the axial direction.

### DETAILED DESCRIPTION

The present disclosure will be described in more detail according to an embodiment. Although description will be made with reference to the drawings as necessary, various elements in the drawings are merely schematically and exemplarily illustrated for understanding of the present disclosure, and appearance, a dimensional ratio, and the like can be different from those of actual ones.

Various numerical ranges referred to herein are intended to include a lower limit and an upper limit numerical values themselves, unless otherwise noted, such as “smaller than” or “more than/larger than”. That is, when a numerical range such as 1 to 10 is taken as an example, it can be interpreted as including “1” as a lower limit and also including “10” as an upper limit. Further, terms such as “about” and “approximately” mean that they may include variation of a few percent, for example, +10%.

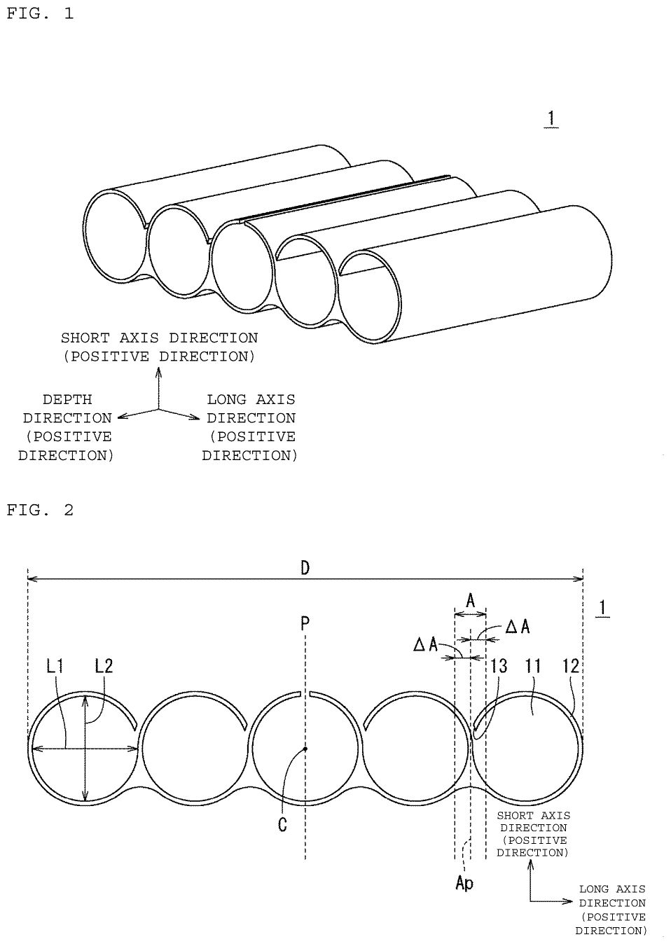

The term “in a plan view” as used herein refers to a state when an object (for example, a battery case) is placed at a location and viewed from directly above in its thickness (height) direction, and is synonymous with a plan View. As an example, “in a plan view” is a state when viewed toward a negative direction in a “short axis direction” illustrated in FIG. 1. The term “in a side view” as used herein refers to a state when the object (for example, the battery case) is placed at a location and viewed from a side perpendicular to the thickness (height) direction unless otherwise specified, and is synonymous with a side view. As an example, “in a side view” is a state when viewed in a negative direction (or a positive direction) in a “long axis direction” illustrated in FIG. 1. The term “in a front view” as used herein refers to a state when the object (for example, the battery case) is placed at a location and viewed from a front perpendicular to the thickness (height) direction unless otherwise specified, and is synonymous with a front view. As an example, “in a front view” is a state when viewed toward a negative direction in a “depth direction” illustrated in FIG. 1. Note that the above-described “positive direction” intends a direction of an arrow in the long axis direction, the short axis direction, or the depth direction illustrated in FIGS. 1 to 7, and the “negative direction” intends a direction opposite to the direction of the arrow in the long axis direction, the short axis direction, or the depth direction illustrated in FIGS. 1 to 7.

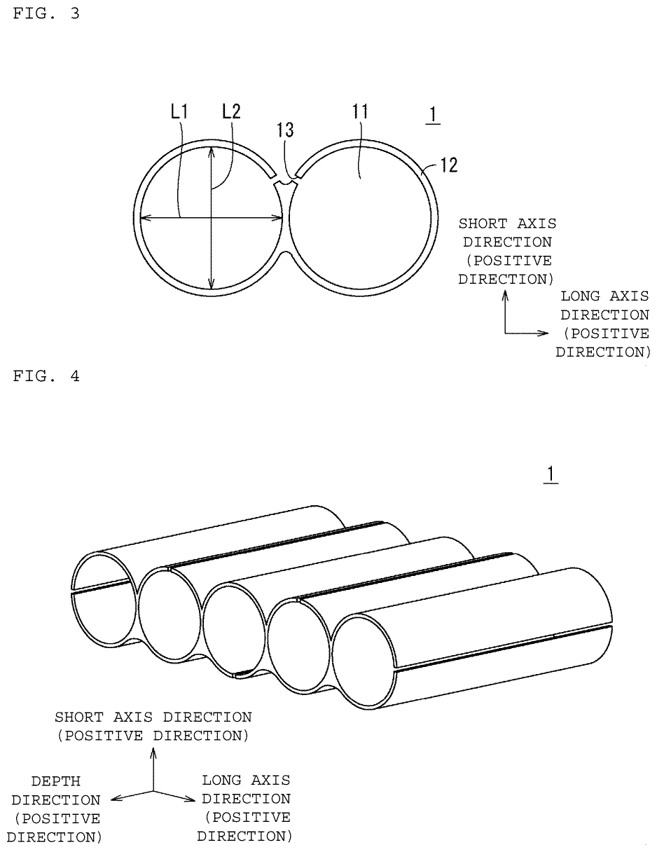

A first embodiment of the battery case of the present disclosure will be described with reference to FIGS. 1 to 3. A battery case 1 includes a plurality of accommodating portions 11 each accommodating one cylindrical battery cell. In FIG. 2 illustrating an example, the number of the accommodating portions 11 is five, but the number of the accommodating portions 11 is not limited to the above example as long as the number is two or more. As an example, as illustrated in FIG. 3, the number of the accommodating portions 11 may be two. Further, the accommodating portions 11 are arranged side by side in one direction. Note that in the present specification, a direction in which the accommodating portions 11 are arranged is defined as the long axis direction, and a direction perpendicular to the long axis direction is defined as the short axis direction. Further, a direction perpendicular to the long axis direction and the short axis direction and parallel to a central axis of the cylindrical battery cell is defined as the depth direction.

The accommodating portion 11 has a wall portion 12 defining a space for accommodating the cylindrical battery cell. Then, the space has an elliptical shape in a front view before the cylindrical battery cell is accommodated. Note that the space is not limited to the elliptical shape because the wall portion 12 is deformed by the cylindrical battery cell after the cylindrical battery cell is accommodated. In FIG. 2 illustrating the example, the elliptical accommodating portion 11 has a long axis diameter L1 and a short axis diameter L2. Note that the term “long axis diameter L1” as used herein is synonymous with a longest length in the long axis direction of the elliptical accommodating portion 11 before accommodating the cylindrical battery cell, and the term “short axis diameter L2 of the elliptical shape” is synonymous with a longest length in the short axis direction of the elliptical accommodating portion 11 before accommodating the cylindrical battery cell. Note that the long axis diameter L1 is configured to be longer than the short axis diameter L2.

The length of the accommodating portion 11 in the depth direction may be equal to or longer than the length of the cylindrical battery cell in the depth direction. By designing the length of the accommodating portion 11 in the depth direction as described above, a contact area between the cylindrical battery cell accommodated in the accommodating portion 11 and the wall portion 12 of the accommodating portion 11 is increased, and heat transfer efficiency can be improved.

Wall portions 12 of the accommodating portions 11 adjacent to each other may be connected to each other. In other words, the wall portions 12 may be integrated as one member. By designing the wall portions 12 in this manner, handling of the wall portions 12 can be facilitated.

A material of the wall portion 12 may be any material as long as it is an elastically deformable member, but is preferably a resin material. In addition, as material properties of the resin material, it is preferable to satisfy any property of a tensile strength of 15 MPa or more, a flexural strength of 15 MPa or more, or a flexural modulus of 4000 MPa or less.

Here, as one characteristic element in the battery pack 100 of the present disclosure, the long axis diameter L1 of the elliptical cylindrical space provided in the accommodating portion 11 is equal to or larger than a diameter of the cylindrical battery cell.

Note that the “diameter of the cylindrical battery cell” as used herein is a concept including a diameter dimension of a maximum value of dimensional tolerance of the cylindrical battery cell in addition to the diameter of the cylindrical battery cell as literally stated. Note that the dimensional tolerance as used herein means a tolerance of +2% of the diameter of the cylindrical battery cell.

According to the battery pack 100 of the present disclosure, the wall portion 12 is elastically deformed when the cylindrical battery cell is accommodated in the accommodating portion 11. Then, since the long axis diameter L1 of the elliptical cylindrical space is equal to or larger than the diameter of the cylindrical battery cell, also when one cylindrical battery cell is accommodated in an accommodating portion 11 and the other cylindrical battery cell is accommodated in an accommodating portion 11 adjacent to the accommodating portion 11, deformation of the accommodating portion 11 accommodating the one cylindrical battery cell in the long axis direction and deformation of the accommodating portion 11 accommodating the other cylindrical battery cell in the long axis direction can be suppressed. Therefore, the cylindrical battery cells can be appropriately accommodated in the accommodating portions 11.

The wall portion 12 may be provided with a slit 13 in parallel with a central axis C of the elliptical cylindrical space. Note that the “central axis of the elliptical cylindrical space” as used herein refers to an axis passing through a center of the elliptic columnar space and extending in parallel with the depth direction described above. That is, the slit 13 is provided in parallel with the depth direction. When the cylindrical battery cell is accommodated in the accommodating portion 11 by providing the slit 13 in the wall portion 12, since the short axis diameter L2 is shorter than the long axis diameter L1, the elliptical cylindrical space is mainly elastically deformed in the short axis direction. Then, an elastic force due to elastic deformation is generated in the short axis direction, and thus the cylindrical battery cell is sandwiched by the wall portion 12 from the short axis direction. That is, elastic deformation of the wall portion 12 in the long axis direction is suppressed.

Further, in the present embodiment illustrated in FIG. 2, the slit 13 is provided in a boundary region A of the accommodating portions 11 adjacent to each other. The term “boundary region” as used herein means a boundary position Ap between the accommodating portions 11 adjacent to each other and a region within a range up to a length AA of +10% of the long axis diameter L1 with respect to the boundary position Ap. In the present embodiment illustrated in FIG. 2, in the accommodating portions 11 excluding a central accommodating portion 11, the slit 13 is provided in the boundary region A between the accommodating portions 11 adjacent to each other, so that an entire region above the cylindrical battery cells can be covered with the wall portions 12. Therefore, by providing the slit 13 in the boundary region A, the cylindrical battery cell can be appropriately brought into close contact with the wall portion 12.

Further, in the present embodiment illustrated in FIG. 2, the slit 13 provided in the accommodating portion 11 located at a center of the battery case 1 is provided at a position overlapping with the central axis C of the accommodating portion 11 in a plan view of the battery case 1. Note that as described above, the term “in a plan view” means a state when viewed toward the negative direction in the short axis direction illustrated in FIG. 1. When the slit 13 is provided as described above, the cylindrical battery cell can be easily accommodated in the accommodating portion 11 located at the center.

Further, in the present embodiment illustrated in FIG. 2, slits 13 formed in the plurality of accommodating portions 11 are plane-symmetrical with respect to a bisecting plane P of the battery case 1 parallel to the short axis diameter L2 of the elliptical cylindrical space. The term “bisecting plane” as used herein means a plane including a perpendicular bisector that bisects a length D (see FIG. 2) parallel to the long axis direction of the battery case 1, and is perpendicular to the long axis direction of the battery case 1. In addition, the term “plane-symmetrical” as used herein means that shapes of an object divided into two when cut along the bisecting plane P are substantially the same. As described above, when the slits 13 are provided to be plane-symmetrical, since the elastic deformation by the wall portions 12 is symmetrical in the direction in which the accommodating portions 11 are arranged, close contact property between the wall portions 12 and the cylindrical battery cells is further improved. Therefore, heat generated from the cylindrical battery cells can be easily transferred to the battery case 1, and heat dissipation of the cylindrical battery cells can be further improved.

Further, in the present embodiment illustrated in FIG. 2, positions of the slits 13 provided in the plurality of accommodating portions 11 are provided above the long axis diameter L1 of the elliptical shape in a front view (in the positive direction in the short axis direction in FIG. 2). In other words, the positions of the slits 13 are provided on the same direction (an upper side) as the positive direction in the short axis direction. By providing the slits 13 as described above, the elastic deformation by the wall portions 12 can be aligned to the same direction, and appropriate elastic deformation can be generated.

Further, in the present embodiment illustrated in FIG. 2, the short axis diameter L2 preferably has a length of 90% or more of the diameter of the cylindrical battery cell accommodated in the accommodating portion 11. Furthermore, the short axis diameter L2 preferably has a length of 100% or less of the diameter of the cylindrical battery cell accommodated in the accommodating portion 11. When the short axis diameter L2 is as described above, the following action and effect are obtained. The accommodating portion 11 has the slit 13, and the short axis diameter L2 has the above length. Thus, when the cylindrical battery cell is accommodated in the accommodating portion 11, the accommodating portion 11 (the wall portion 12) can be elastically deformed such that the space for accommodating the cylindrical battery cell expands to such an extent that the accommodating portion 11 is not broken. This makes it possible to prevent the battery case 1 (the wall portion 12) from being broken when the cylindrical battery cell is accommodated in the accommodating portion 11.

Further, when the short axis diameter L2 is as described above, a contact area between the wall portion 12 and a surface of cylindrical battery cell can be increased. First, as a comparative example, a case where the short axis diameter L2 has a length of less than 90% of the diameter of the cylindrical battery cell accommodated in the accommodating portion 11 will be described. In this case, when the cylindrical battery cell is accommodated in the accommodating portion 11, a width (a length in the long axis direction) of the slit 13 is further extended as compared with the present embodiment. In other words, the contact area between the wall portion 12 and the cylindrical battery cell is reduced. This makes it difficult to transfer the heat generated from the cylindrical battery cells to the battery case 1.

In contrast, in the present embodiment, since the short axis diameter L2 is as described above, extension of the width (length in the long axis direction) of the slit 13 when the cylindrical battery cell is accommodated in the accommodating portion 11 can be minimized. That is, the contact area between the wall portion 12 and the surface of the cylindrical battery cell can be made larger than that in the comparative example. Thus, the heat generated from the cylindrical battery cells can be easily transferred to the battery case 1, and the heat dissipation of the cylindrical battery cells can be further improved.

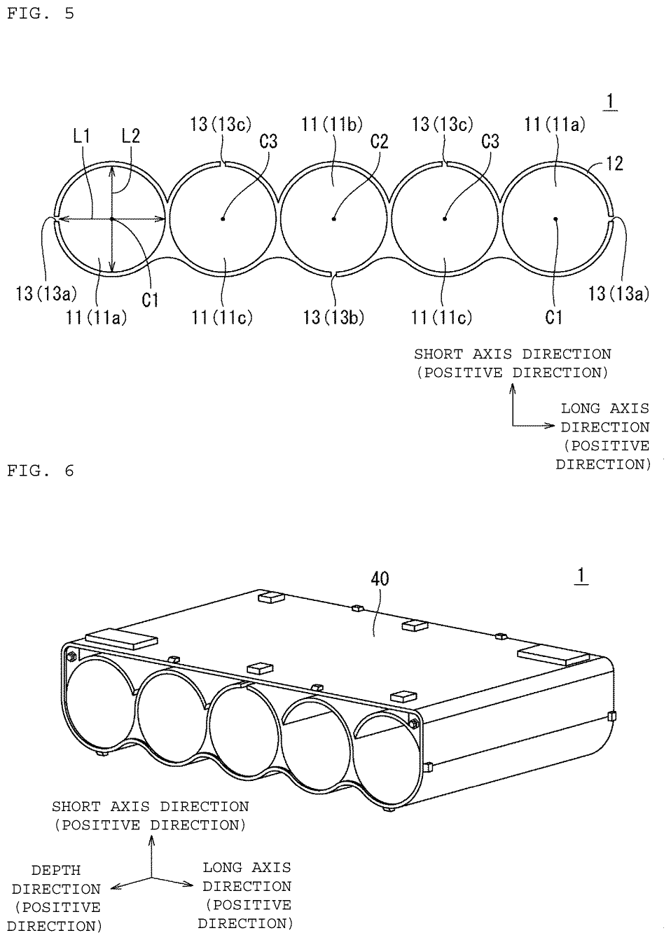

A second embodiment of the battery case of the present disclosure will be described with reference to FIGS. 4 and 5. The second embodiment is different from the first embodiment in position of the slit 13 provided in the wall portion 12. Other configurations are basically the same as those of the first embodiment described above. Hereinafter, this different configuration will be described.

In the present embodiment, a slit 13 (13a) provided in an accommodating portion 11 located outermost (hereinafter referred to as an outermost accommodating portion 11a) among the plurality of accommodating portions 11 is provided to overlap with the central axis C1 of the elliptical cylindrical space in the accommodating portion 11a in a side view of the battery pack 100.

When a position of the slit 13a in the outermost accommodating portion 11a is set to the above position, it is possible to suppress variation in position of outermost accommodating portion 11a in the short axis direction before and after the cylindrical battery cell is accommodated in the outermost accommodating portion 11a.

In the present embodiment, slits 13 (13b and 13c) provided in accommodating portions 11 (11b and 11c) located inside the outermost accommodating portion 11a among the plurality of accommodating portions 11 are provided at positions overlapping central axes C (C2 and C3) of the elliptical cylindrical space in the accommodating portions 11 (11b and 11c) in a plan view of the battery case 1. In FIG. 5 illustrating an example, the slit 13b of the accommodating portion 11b located at a center (hereinafter referred to as a central accommodating portion 11b) is provided in a lower portion of the central accommodating portion 11b (the negative direction in the short axis direction in FIG. 5). In contrast, the slit 13c of the accommodating portion 11c between the central accommodating portion 11b and the outermost accommodating portion 11a (hereinafter referred to as an intermediate accommodating portion 11c) is provided in an upper portion of the intermediate accommodating portion 11c (the positive direction in the short axis direction in FIG. 5).

The action and effect of the above configuration will be described with reference to FIG. 5. First, when the cylindrical battery cell is accommodated in the central accommodating portion 11b, the slit 13b is expanded. Thus, the intermediate accommodating portion 11c and the outermost accommodating portion 11a move in the positive direction in the short axis direction in FIG. 5. In other words, arrangement of the accommodating portions 11a to 11c of the battery case 1 as viewed from a direction of the central axes C1 to C3 is V-shaped (not illustrated).

Subsequently, when the cylindrical battery cell is accommodated in the intermediate accommodating portion 11c, the slit 13c is expanded. Thus, the outermost accommodating portion 11a moves in the negative direction in the short axis direction in FIG. 5 (not illustrated).

Finally, also when the cylindrical battery cell is accommodated in the outermost accommodating portion 11a, as described above, the variation in the position of the outermost accommodating portion 11a (variation in the short axis direction in FIG. 5) is suppressed. Note that an order of accommodating the cylindrical battery cells in the accommodating portion 11a is not limited to the above-described order of the central accommodating portion 11b, the intermediate accommodating portion 11c, and the outermost accommodating portion 11a. For example, the cylindrical battery cell may be initially accommodated in the outermost accommodating portion 11a, or the cylindrical battery cell may be initially accommodated in the intermediate accommodating portion 11b.

By these actions, deformation of the battery case 1 (in other words, deformation of entire battery case 1 in an up-down direction (the short axis direction)) before and after the cylindrical battery cells are accommodated can be suppressed.

Furthermore, in the present embodiment, in the accommodating portions 11b and 11c located inside the outermost accommodating portion 11a among the plurality of accommodating portions 11, the slits 13 of the accommodating portions 11 adjacent to each other are staggered in a front view of the battery case 1. The term “staggered” as used herein means that when slit positions of the accommodating portions 11 adjacent to each other are rotated by 180° about a center between the accommodating portions 11, the slit positions overlap each other. With such a configuration, stress on the cylindrical battery cells generated by the wall portions 12 can be dispersed, and all the cylindrical battery cells and the battery case 1 can be brought into closer contact with each other. In addition, since deformation amounts on left and right sides of the battery case 1 can be the same with each other with respect to the central accommodating portion 11b as an axis, it is possible to suppress the deformation of the battery case 1 in the up-down direction (short axis direction in FIG. 5).

Note that FIG. 5 illustrating an example of the present embodiment illustrates an aspect in which the slits 13c of the intermediate accommodating portions 11c are formed in the upper portion (the positive direction in the short axis direction), and the slit 13b of the central accommodating portion 11b is formed in the lower portion (the negative direction in the short axis direction), but the present disclosure is not limited to this aspect. For example, the same effect can also be obtained in an aspect in which the slits 13c of the intermediate accommodating portions 11c are formed in the lower portion (the negative direction in the short axis direction) and the slit 13b of the central accommodating portion 11b is formed in the upper portion (the positive direction in the short axis direction).

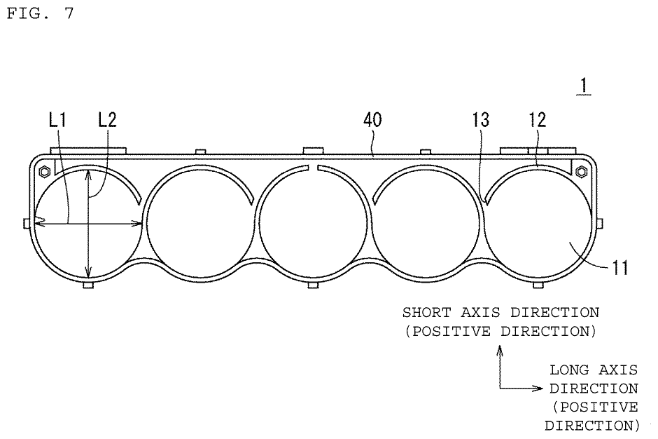

A third embodiment of the battery case of the present disclosure will be described with reference to FIGS. 6 and 7. The third embodiment is different from the first embodiment and the second embodiment described above in that a connection member for connecting the wall portions of the accommodating portions located outermost is provided. Other configurations are basically the same as those of the first and second embodiments described above. Hereinafter, this different configuration will be described.

A connection member 40 of the present embodiment connects the wall portions 12 of the accommodating portions 11 located outermost. By providing the connection member 40, strength of the battery case 1 can be improved. Further, since the connection member 40 connects the wall portions 12 of the accommodating portions 11 located outermost, it is possible to reduce deformation of a dimension of the battery case 1 in the long axis direction. That is, the deformation of the entire battery case 1 can be suppressed.

As a material of the connection member 40, it is preferable to use the same resin material as the material of the wall portion 12 described above, but a material different from the material of the wall portion 12 may be used.

Further, the connection member 40 may be provided with a control circuit for controlling the electric power of the cylindrical battery cell. That is, the connection member 40 can also act as a member for mounting the control circuit. Therefore, by providing the connection member 40 as in the present embodiment, the surface portion can be effectively used.

Note that the embodiments disclosed herein are illustrative in all respects, and the present application is not limited thereto.

The battery case of the present disclosure includes the following aspects according to an embodiment.

<1> A battery case including a plurality of accommodating portions each accommodating one cylindrical battery cell, the accommodating portions being arranged side by side in one direction, in which
each of the accommodating portions has a wall portion defining a space for accommodating the cylindrical battery cell,
the wall portion in a state before accommodating the cylindrical battery cell defines an elliptical cylindrical space,
a direction in which the accommodating portions are arranged in one direction is defined as a long axis direction of the elliptical cylindrical space, a direction perpendicular to the long axis direction is defined as a short axis direction, and a direction perpendicular to the long axis direction and the short axis direction and parallel to a central axis of the elliptical cylindrical space is defined as a depth direction, and
a longest long axis diameter in the long axis direction of the elliptical cylindrical space in each of the accommodating portions is equal to or larger than a diameter of the cylindrical battery cell.

<2> The battery case according to <1>, in which a slit is provided in the wall portion in parallel with the central axis of the elliptical cylindrical space.

<3> The battery case according to <1> or <2>, in which slits formed in the plurality of accommodating portions are plane-symmetrical with respect to a bisecting plane of the battery case parallel to a longest short axis diameter in the short axis direction of the elliptical cylindrical space.

<4> The battery case according to <2> or <3>, in which the slit is provided in a boundary region between the accommodating portions adjacent to each other.

<5> The battery case according to any one of <1> to <4>, in which a slit formed in an accommodating portion positioned at a center of the battery case is provided at a position overlapping with the central axis of the elliptical cylindrical space in the accommodating portion in a plan view of the battery case.

<6> The battery case according to any one of <1> to <5>, in which a slit provided in an accommodating portion located outermost among the plurality of accommodating portions is provided at a position overlapping with the central axis of the elliptical cylindrical space in the accommodating portion in a side view of the battery case.

<7> The battery case according to any one of <1> to <6>, in which a slit provided in an accommodating portion located inside an accommodating portion located outermost among the plurality of accommodating portions is provided at a position overlapping with the central axis of the elliptical cylindrical space in the accommodating portion in a plan view of the battery case.

<8> The battery case according to any one of <1> to <7>, in which slits of accommodating portions adjacent to each other are staggered in a front view of the battery case in an accommodating portion located inside an accommodating portion located outermost among the plurality of accommodating portions.

<9> The battery case according to any one of <1> to <8>, including a connection member for connecting wall portions of accommodating portions located outermost.

<10> The battery case according to any one of <1> to <9>, in which a length of the accommodating portion in the depth direction is equal to or longer than a length of the cylindrical battery cell to be accommodated in the accommodating portion in the depth direction.

<11> The battery case according to any one of <1> to <10>, in which wall portions of the accommodating portions adjacent to each other are connected to each other.

<12> The battery case according to any one of <1> to <11>, in which a longest short axis diameter in the short axis direction of the elliptical cylindrical space in the accommodating portion has a length of 90% or more of the diameter of the cylindrical battery cell.

The present disclosure can be used for a battery case capable of appropriately accommodating the cylindrical battery cells according to an embodiment.

### DESCRIPTION OF REFERENCE SYMBOLS

1: Battery case
11, 11a to 11c: Accommodating portion
12: Wall portion
13, 13a to 13c: Slit
40: Connection member
100: Battery pack
A: Boundary region
Ap: Boundary position
C1 to C3: Central axis
L1: Long axis diameter
L2: Short axis diameter
P: Bisecting plane

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery case comprising:
a plurality of accommodating portions each accommodating one cylindrical battery cell, the accommodating portions being arranged side by side in one direction, wherein
each of the accommodating portions has a wall portion defining a space for accommodating the cylindrical battery cell,
the wall portion in a state before accommodating the cylindrical battery cell defines an elliptical cylindrical space,
a direction in which the accommodating portions are arranged in one direction is defined as a long axis direction of the elliptical cylindrical space, a direction perpendicular to the long axis direction is defined as a short axis direction, and a direction perpendicular to the long axis direction and the short axis direction and parallel to a central axis of the elliptical cylindrical space is defined as a depth direction, and
a longest long axis diameter in the long axis direction of the elliptical cylindrical space in each of the accommodating portions is equal to or larger than a diameter of the cylindrical battery cell.

2. The battery case according to claim 1, wherein a slit is provided in the wall portion in parallel with the central axis of the elliptical cylindrical space.

3. The battery case according to claim 1, wherein slits formed in the plurality of accommodating portions are plane-symmetrical with respect to a bisecting plane of the battery case parallel to a longest short axis diameter in the short axis direction of the elliptical cylindrical space.

4. The battery case according to claim 2, wherein the slit is provided in a boundary region between the accommodating portions adjacent to each other.

5. The battery case according to claim 1, wherein a slit formed in an accommodating portion positioned at a center of the battery case is provided at a position overlapping with the central axis of the elliptical cylindrical space in the accommodating portion in a plan view of the battery case.

6. The battery case according to claim 1, wherein a slit provided in an accommodating portion located outermost among the plurality of accommodating portions is provided at a position overlapping with the central axis of the elliptical cylindrical space in the accommodating portion in a side view of the battery case.

7. The battery case according to claim 1, wherein a slit provided in an accommodating portion located inside an accommodating portion located outermost among the plurality of accommodating portions is provided at a position overlapping with the central axis of the elliptical cylindrical space in the accommodating portion in a plan view of the battery case.

8. The battery case according to claim 1, wherein slits of accommodating portions adjacent to each other are staggered in a front view of the battery case in an accommodating portion located inside an accommodating portion located outermost among the plurality of accommodating portions.

9. The battery case according to claim 1, comprising a connection member for connecting wall portions of accommodating portions located outermost.

10. The battery case according to claim 1, wherein a length of the accommodating portion in the depth direction is equal to or longer than a length of the cylindrical battery cell to be accommodated in the accommodating portion in the depth direction.

11. The battery case according to claim 1, wherein wall portions of the accommodating portions adjacent to each other are connected to each other.

12. The battery case according to claim 1, wherein a longest short axis diameter in the short axis direction of the elliptical cylindrical space in the accommodating portion has a length of 90% or more of the diameter of the cylindrical battery cell.
